(19) United States
(12) Patent Application Publication
(10) Pub. No.: US 2014/0129006 A1
(43) Pub. Date: May 8, 2014

(54) SMART GATEWAY, SMART HOME SYSTEM AND SMART CONTROLLING METHOD THEREOF

(71) Applicants: Hon Hai Precision Industry Co., Ltd., New Taipei (TW); Hong Fu Jin Precision Industry (ShenZhen) Co., Ltd., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 14/071,569

(22) Filed: Nov. 4, 2013

(30) Foreign Application Priority Data
Nov. 6, 2012 (CN) 2012104367260

(51) Int. Cl. G05B 15/02

(52) U.S. Cl. CPC G05B 15/02
USPC 700/90

(57) ABSTRACT

A smart controlling method applied to a smart home system for controlling a number of home appliances which may detect and act upon the approach of a user to the smart home. The smart home system learns the habits of a user from repeated inputs at repeated times by the same user to determine that a control command is a habit. When the user arrives at home or is discovered in proximity to the smart home, the smart home system calls a control command to control a relevant home appliance to execute certain operations. A smart gateway and a smart home system are also provided.

### BACKGROUND

1. Technical Field

The present disclosure relates to smart home technology, and particularly to a smart gateway, a smart home system, and a smart controlling method for controlling home appliances and devices of the smart home system.

2. Description of Related Art

Smart home technology is popular. With this technology, all home devices in a house are connected to a smart home network system, so as to be controlled in unison, allowing a user to easily control the home devices from anywhere in the house. Most home appliances or devices need to be coupled to a special controller, which is complicated. However, it is problematic for the smart home network system to automatically control the home devices according to the changing habits and preferences of the user.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view showing a smart home system, according to an exemplary embodiment.

FIG. 2 is a block diagram of the smart home system of FIG. 1.

FIG. 3 is a block diagram of a smart gateway of the smart home system of FIG. 1.

FIG. 4 is a block diagram showing a second Power Line Communication modern unit of home appliances of FIG. 1.

FIG. 5 is a block diagram of a remote controller of the smart home system of FIG. 1.

FIG. 6 is a schematic view showing an operation controlling interface displayed on the Internet controller of the smart home system of FIG. 1.

FIG. 7 is a block diagram of the smart home system coupled with a number of registration controllers.

FIG. 8 is a diagram showing a mapping table used in the home system of FIG. 7.

FIG. 9 is a block diagram of the smart home system coupled with only one registration controller.

FIG. 10 is a diagram showing a mapping table used in the home system of FIG. 9.

FIG. 11 is a flowchart illustrating a remote controlling method for controlling the home appliances of the smart home system of FIG. 2, according to an exemplary embodiment.

FIG. 12 is a sub-flowchart of the remote controlling method of FIG. 11.

FIG. 13 is a block diagram of the smart home system, according to another embodiment.

FIG. 14 is a diagram showing a recording table used in the home system of FIG. 13.

FIG. 15 is a diagram showing a intelligent command table used in the home system of FIG. 13.

FIG. 16 is a flowchart illustrating an intelligent controlling method for controlling the home appliances of the smart home system of FIG. 13, according to an exemplary embodiment.

FIG. 17 is a flowchart illustrating a habit learning method of the smart home system of FIG. 13, according to an exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

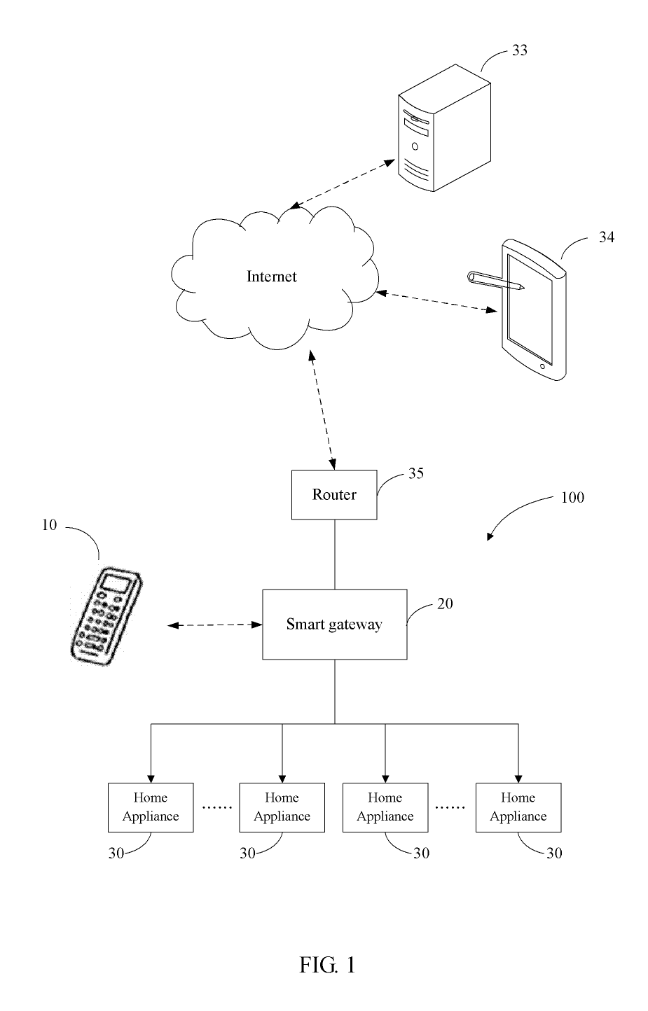

Referring to FIG. 1, a smart home system 100 is provided. The smart home system 100 includes a smart gateway 20 communicating with a server 33 and an Internet controller 34 via the Internet. The smart gateway 20 is connected to a wired or wireless router 35, thereby communicating with the Internet via the router 35. The Internet controller 34 can be a computer, a portable notebook, or the like connecting to the Internet via a wired or wireless Ethernet interface unit. The Internet controller 34 can also be a smart phone, a personal digital assistant (PDA), a tablet PC, or the like connecting to the Internet via the General Packet Radio Service (GPRS) network, the Code Division Multiple Access (CDMA) network, the 3^{rd} Generation (3G) Telecommunication network, the 4^{th} Generation (4G) Telecommunication network, or other networks of mobile Internet. The server 33 also connects to the Internet, thereby communicating with the smart gateway 20 and the Internet controller 34.

In this embodiment, the smart home system 100 further includes a remote controller 10. The remote controller 10 communicates with the smart gateway 20 via a wired or wireless communication mode. The remote controller 10 sends a control command to the smart gateway 20 according to a user's input, and the smart gateway 20 controls the home appliances 30 to execute an operation according to the control command. Furthermore, the smart gateway 20 receives the control command sent by the server 33 or the Internet controller 34, to control the home appliances 30 to execute the operations. The wireless communication mode includes, but is not limited to, Infrared (IR), BLUETOOTH, Z-wave, NFC, ZigBee, WIFI, or other communication technologies; the wired communication mode can be Power Line Communication (hereinafter PLC), Optical Fiber Power Line Communication (hereinafter OPLC), wired Internet communication, coaxial cable communication, telephone line communication, or other communication technologies.

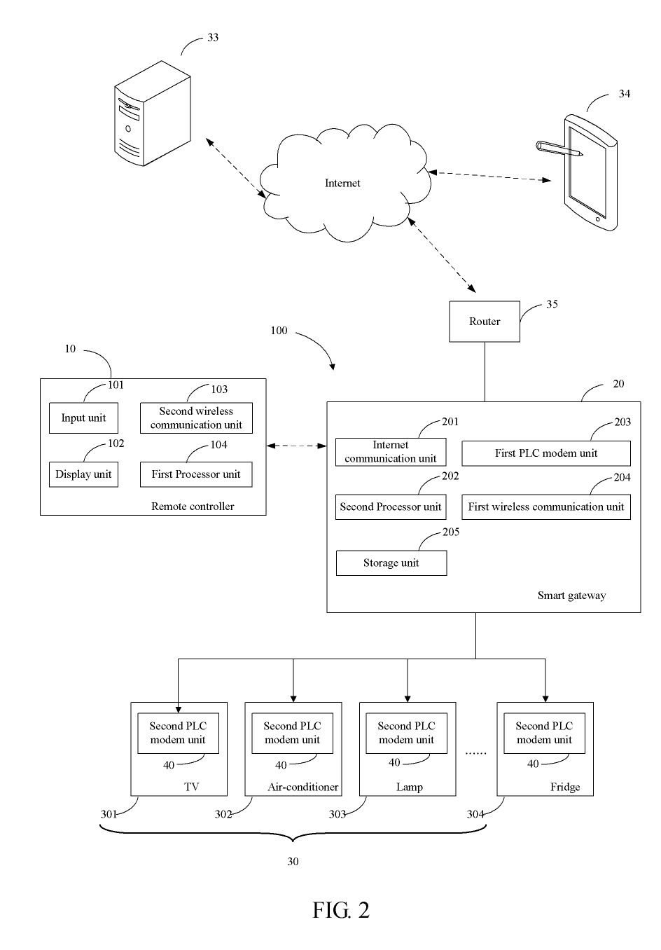

Referring to FIG. 2, a block diagram of the smart home system 100 is provided. The smart gateway 20 includes an Internet communication unit 201, a second processor unit 202, a first PLC modem unit 203, a first wireless communication unit 204, and a storage unit 205.

The smart gateway 20 communicates with each of the home appliances 30 in a wired or wireless communication mode, wherein the wireless communication mode includes, but is not limited to, Infrared (IR), BLUETOOTH, Z-wave, NFC, Zigbee, WIFI, or other communication technologies; the wired communication mode can be PLC, OPLC, wired Internet communication, coaxial cable communication, telephone line communication, or other communication technologies. In this embodiment, the smart gateway 20 communicates with the home appliances 30 via the PLC technologies, the smart gateway 20 and parts of the home appliances 30 are connected to the power line. The power line not only supplies power to all electrical devices of consumers, but also serves as a carrier for data transmission between the smart gateway 20 and the home appliances 30. In other embodiments, the smart gateway 20 and the home appliances 30 are connected by an Optical Fiber Composite Low-voltage Cable, and communicate with each other via the OPLC technologies.

The storage unit 205 is configured for storing system information of the home system 100. The system information includes unique identification codes (UIDs) of the home appliances 30, location and setting parameters of the router 35, and verification information of registered users of the smart home system 100. The verification information includes a user name and secret code of the registered user.

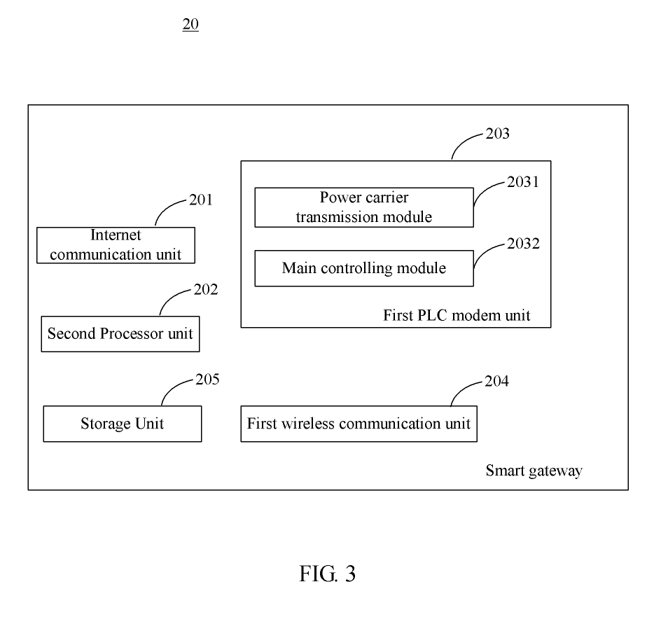

Referring to FIG. 3, the first PLC modem unit 203 includes a power carrier transmission module 2031 and a main controlling module 2032. The main controlling module 2032 is configured for encoding and transmitting data. The power carrier transmission module 2031 is configured for modulating electronic signals into the power line and demodulating electronic signals from the power line.

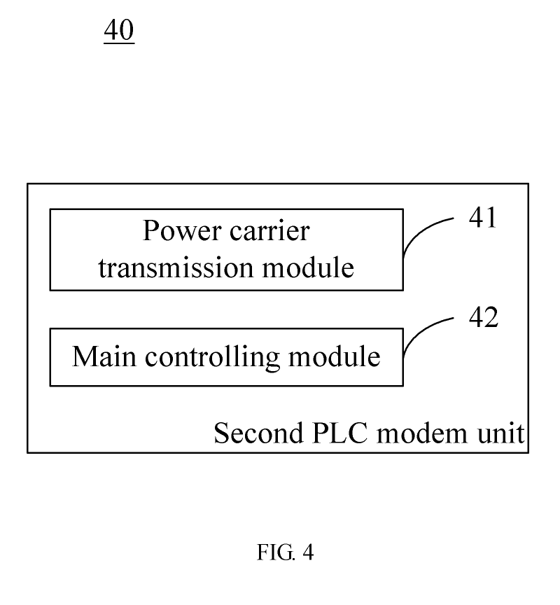

Referring to FIGS. 2 and 4, the home appliances 30 include, but are not limited to, a television 301, an air-conditioner 302, a lamp 303, a fridge 304, a door-keeper system (not shown), a socket(not shown), a fan(not shown), and an automatic curtain (not shown). Each of the home appliances 30 includes a second PLC modem unit 40, which is similar to the first PLC modem unit 203. The second PLC modem unit 40 includes a power carrier transmission module 41 configured for loading electronic signals to the power line and demodulating electronic signals from the power line, and a main controlling module 42 configured for data interacting, demodulating, encoding, and protocol converting.

The smart gateway 20 and the home appliances 30 each include a unique identification code (UID), all of the UIDs of the home appliances 30 are stored in the smart gateway 20, so that each of the home appliances 30 can be identified by the smart gateway 20. In detail, the first PLC modem unit 203 of the smart gateway 20 sends control signals that include the identification information of the target home appliance 30, and the second PLC modem unit 40 of the home appliances 30 determines whether or not the identification information of the received control signal matches their UID. Only the home appliance 30 with a matching UID creates a point-to-point communication between the smart gateway 20 and the matched home appliance 30.

Referring to FIG. 2 again, the remote controller 10 includes an input unit 101, a display unit 102, a second wireless communication unit 103, and a first processor unit 104. The first processor unit 104 generates a controlling command according to a user's input and sends the controlling command to the smart gateway 20 via the second wireless communication unit 103. The controlling command includes an operation command and the identification information of a target home appliance 30, which is assigned to execute the operation command.

The remote controller 10 can communicate with the smart gateway 20 in a wired or wireless communication mode, wherein the wireless communication mode includes, but is not limited to, Infrared (IR), BLUETOOTH, Z-wave, NFC, ZIGBEE, WIFI, or other communication technologies; the wired communication mode can be Power Line Communication (hereinafter PLC), Optical Fiber Power Line Communication (hereinafter OPLC), wired Internet communication, coaxial cable communication, telephone line communication, or other communication technologies. In this embodiment, the remote controller 10 communicates with the smart gateway 20 via WIFI communication, the second wireless communication unit 103 of the remote controller 10 and the first wireless communication unit 204 of the smart gateway 20 each includes a WIFI communication module. In other embodiments, the remote controller 10 communicates with the smart gateway 20 via Infrared (IR) communication, and some of the home appliances 30, such as the television 301 or the air-conditioner 302, also receive Infrared (IR) control signals. The remote controller 10 directly sends Infrared (IR) control signals to this kind of home appliances 30 to control them.

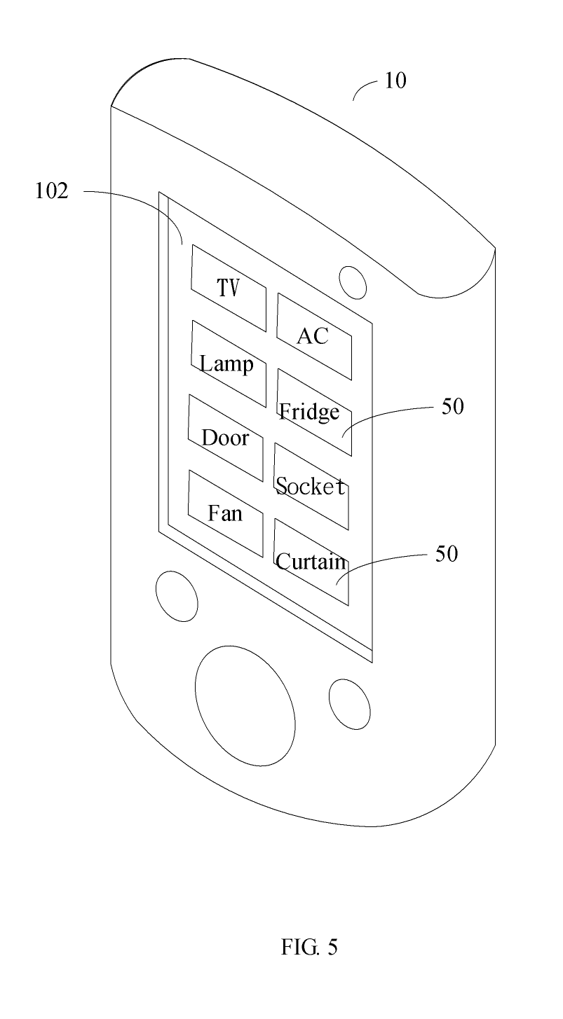

Referring to FIG. 5, an operation controlling interface of the remote controller 10 is provided. In this embodiment, the input unit 101 of the remote controller 10 is a touch screen. A controlling program is preloaded in the remote controller 10. The controlling program can be, but is not limited to, downloaded from an online applications store. The first processor unit 104 of the remote controller 10 runs the controlling program to display the operation controlling interface on the display unit 102. In detail, a number of icons 50 are displayed on the operation controlling interface. Each of the icons 50 corresponds to one of the home appliances 30. For example, the operation controlling interface displayed on the display unit 102 provides a layout of a house, and the icons 50 are arranged according to the arrangement of the home appliances 30 in the house. Users can select any of the home appliances 30 by choosing an icon 50 displayed on the display unit 102 by the input unit 101. The display unit 102 of the remote controller 10 further provides an operation menu of the selected home appliance 30 for entering selections. The first processor unit 104 responds to a user's selection, and sends the controlling command, which includes the selected operation command and the identification information of the selected home appliance 30, to the smart gateway 20 via the second wireless communication unit 103. In other embodiments, the input unit 101 is a plurality of buttons.

In this embodiment, the server 33 can be, but is not limited to, a cloud server with cloud storage and computing functions. The system information of the smart home system 100 is also stored in the server 33, as disclosed in paragraph [0020]. The system information includes the UIDs of the home appliances 30, a location and setting parameters of the smart gateway 20, and verification information of registered users of the smart home system 100. The verification information includes a user name and a secret code of the registered user.

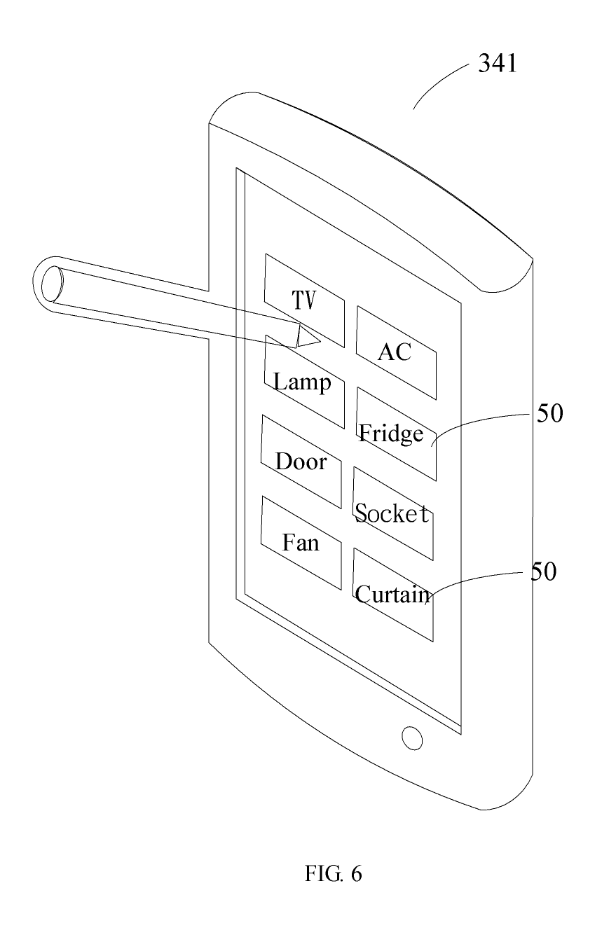

Referring to FIG. 6, in this embodiment, the Internet controller 34 is a smart portable device 341. The smart portable device 341 connects to the Internet via a WIFI (Wireless Fidelity) or WAPI (Wireless LAN Authentication and Privacy Infrastructure) network, General Packet Radio Service (GPRS) network, the Code Division Multiple Access (CDMA) network, the 3^{rd} Generation (3G) Telecommunication network or the 4^{th} Generation (4G) Telecommunication network, or the other networks of mobile Internet.

The smart portable device 341 also contains a smart home controlling program to run therein. When the smart home controlling program runs in the smart portable device 341, the smart portable device 341 sends an user name and a password input by the user to the server 33. The server 33 verifies whether or not the user name and the password is valid. If yes, the server 33 sends the system information of the home system 10 related to the user name to the smart portable device 341. The smart portable device 341 displays the operation controlling interface according to the system information. The operation interface provides a building layout of the house and a plurality of icons 50 corresponding to the home appliances 30. The icons 50 are arranged according to the arrangement of the home appliances 30 in the house. The smart portable device 341 also establishes communication with the smart gateway 20 according to the location and setting parameters of the router 35. The smart portable device 341 further provides the operations menu of the selected home appliance 30 for entering selections. The smart portable device 341 responds to a user's selection and sends the controlling command, which includes the selected operation command and the identification information of the selected home appliance 30, to the smart gateway 20.

In another embodiment, a peer to peer (P2P) technology is used. After the server 33 verifies the user name and the password sent by the smart portable device 341, the smart portable device 341 sends the controlling command, which includes the operation command and the identification information of the selected home appliance 30, to the router 35 directly. The router 35 transmits the controlling command to the smart gateway 20.

In another embodiment, the server 33 is a web server configured to provide the operation controlling interface. The smart portable device 341 accesses the server 33 to obtain the operation controlling interface. In detail, the server 33 verifies whether or not the user name and the password sent by the smart portable device 341 is valid, and permits the smart portable device 341 to download a web page of the operation controlling interface when the user name and the password is valid. The smart portable device 341 responds to a user's selection, and sends the controlling command including the operation command and the identification information of the selected home appliance 30 to the smart gateway 20. The operation controlling interface provides a building layout of the house and a number of icons 50 relating to the home appliances 30. The icons 50 are arranged according to the arrangement of the home appliances 30 in the house. The smart portable device 341 further provides the operations menu of the selected home appliance 30 for entering selections. The smart portable device 341 responds to a user's selection and sends the controlling command, which includes the operation command and the identification information of the selected home appliance 30 to the smart gateway 20.

In other embodiments, smart phone, personal digital assistant (PDA), or tablet PCs capable of connecting to the Internet via a wireless network, such as WIFI network, can serve as the Internet controller 34. The first wireless communication unit 204 of the smart gateway 20 can establish communication to the Internet controller 34, and receives the controlling command sent by the Internet controller 34 directly. This connecting manner is suitable for short range wireless communication, the smart gateway 20 can establish communication to the Internet controller 34 directly without bridging by the server 33.

The smart gateway 20 is connected to the Internet by the Internet communication unit 201. The server 33 and the Internet controller 34 are also connected to the Internet. The Internet communication unit 201 of the smart gateway 20 transmits the controlling commands sent by the server 33 or the Internet controller 34 to the second processor unit 202. The Internet communication unit 201 can be a wired Ethernet interface unit configured for connecting the smart gateway 20 to the router 35, thereby connecting the smart gateway 20 to the Internet. In other embodiments, the Internet communication unit 201 can be a WIFI or WAPI communication unit configured for connecting the smart gateway 20 to the router 35 wirelessly.

The second processor unit 202 receives the controlling commands sent by the server 33 or the Internet controller 34. The controlling command includes an operation command and the identification information of the home appliance 30, which executes the operation command. In this embodiment, the identification information is the UID of the home appliance 30. The second processor unit 202 further extracts the operation command and the UID of the home appliance 30, which executes the operation command from the controlling command.

The first PLC modem unit 203 sends a controlling signal, which includes the operation command and the UID of a home appliance 30, to the home appliance 30. The home appliance 30 that has the matching UID in the controlling signal executes the operation command. In detail, the main controlling module 2032 of the first PLC modem unit 203 encodes the controlling signal according to the operation command and the UID of the home appliance 30. The power carrier transmission module 2031 loads the controlling signal to the power line for sending the controlling signal to the target home appliance 30.

The home appliance 30 receives the controlling signal sent by the smart gateway 20 via the second PLC modem unit 40, and executes the operation according to the operation command included in the controlling signal. In detail, the power carrier transmission module 41 of the second PLC modem unit 40 demodulates controlling signals from the power line and determines whether or not the UID of the controlling signal matches the UID of itself. If the UIDs match, the power carrier transmission module 41 receives and parses the controlling signal; the main controlling module 42 extracts the operation command included in the controlling signal, and the home appliance 30 executes the required operation according to the operation command.

The smart home system 100 is connected to the Internet. The smart gateway 20 is not only capable of receiving the controlling command sent by the remote controller 10, but also capable of receiving the controlling command sent by the server 33 or the Internet controller 34. Users can remotely control the home appliance 30 in the smart home system 100 with the Internet controller 34, such as a common smart electronic device.

The first PLC modem unit 203 and the second PLC modem unit 40 communicate with each other. The UID of the smart gateway 20 is stored in the home appliance 30. Therefore, the home appliance 30 sends signals to the smart gateway 20 via power lines, and the first PLC modem unit 203 of the smart gateway 20 receives the signals via the power lines.

In other embodiments, the home appliances 30 connect to the smart gateway 20 wirelessly. Each UID of the home appliances 30 is uniquely identified by the smart gateway 20. Each of the home appliances 30 and the smart gateway 20 include a wireless communication module, such as BLUETOOTH, Z-wave, NFC, ZIGBEE, WIFI or WAPI communication module.

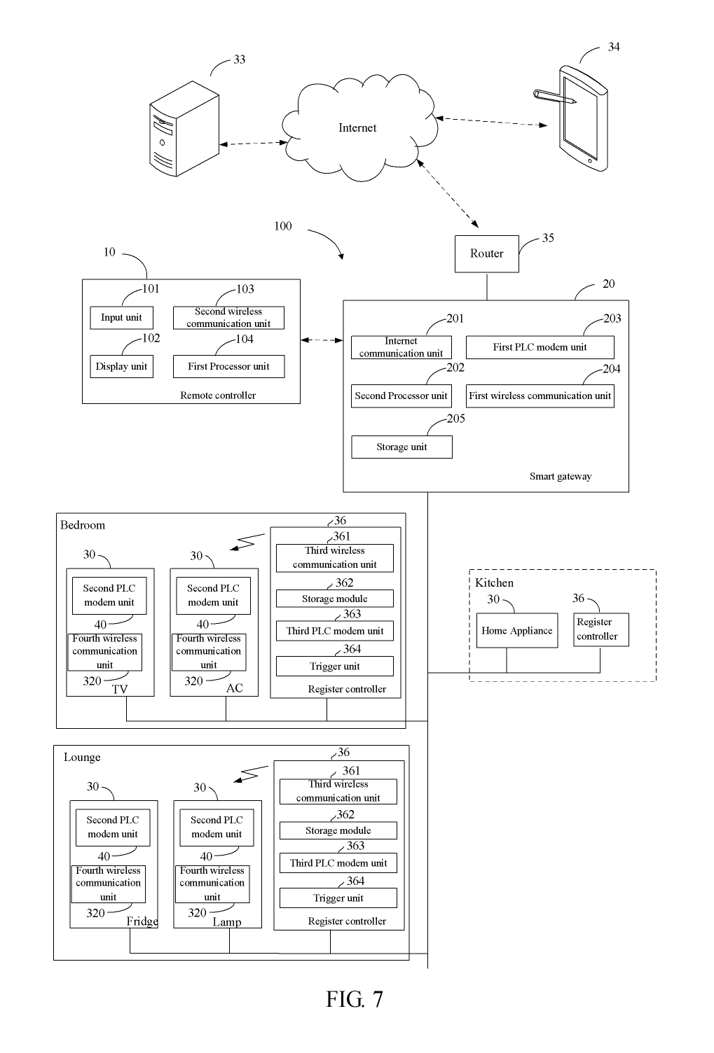

Referring to FIG. 7, the smart home system 100 further includes at least one registration controller 36. In this embodiment, the smart home system 100 includes a number of registration controllers 36 arranged in rooms of the smart home system 100. The registration controller 36 includes a third wireless communication unit 361, a storage module 362, a third PLC modem unit 363, and a trigger unit 364. In this embodiment, the registration controllers 36 are connected to the power line, and communicate with the home appliances 30 via the PLC modem units. Each of the registration controllers 36 includes an UID stored in the storage module 362.

In this embodiment, the third wireless communication unit 361 includes an Infrared (IR) communication unit. The first wireless communication unit 204 of the smart gateway 20 also includes an Infrared (IR) communication unit. The registration controllers 36 communicate with the smart gateway 20 via Infrared (IR) communication. Each of the home appliances 30 includes a fourth wireless communication unit 320. The fourth wireless communication unit 320 also includes an Infrared (IR) communication unit for establishing communication with the registration controllers 36. The third wireless communication unit 361 sends out Infrared (IR) signals. In other embodiments, the third wireless communication unit 361 and the fourth wireless communication unit 320 can use BLUETOOTH, Z-wave, NFC, ZIGBEE, WIFI, or other communication technologies.

Each of the home appliances 30 needs to be registered in the smart gateway 20, so as to allow the smart gateway 20 to recognize the home appliance 30. A user uses the registration controller 36 to control the home appliances 30 in a room to automatically register with the smart gateway 20.

The registration controller 36 needs to be registered in the smart home system 100 in an initial state. To register the registration controller 36, the registration controller 36 is connected to the power supply and is located within the communicating range of the first wireless communication unit 204 of the smart gateway 20, and a registering program is run on the smart gateway 20. Then, the first wireless communication unit 204 of the smart gateway 20 establishes communication with the third wireless communication unit 361 of the registration controller 36, and the smart gateway 20 sends its UID to the registration controller 36. The registration controller 36 receives the UID of the smart gateway 20 and saves it in the storage module 362, thereby completing the registration process.

After registering the registration controller 36 in the smart home system 100, the home appliances 30 can be registered in the smart gateway 20. When the registration controller 36 is connected to the power line, the registration controller 36 sends a registering code to the home appliances 30 located within the communication range of the registration controller 36 via the third wireless communication unit 361, and sends a register request to the smart gateway 20 via the third PLC modem unit 363, in response to a user's input on the trigger unit 364. The registering code includes the UID of the smart gateway 20 and the UID of the registration controller 36, and the register request includes the UID of the registration controller 36. In this embodiment, the communication range of the registration controller 36 is within the room where the registration controller 36 is placed.

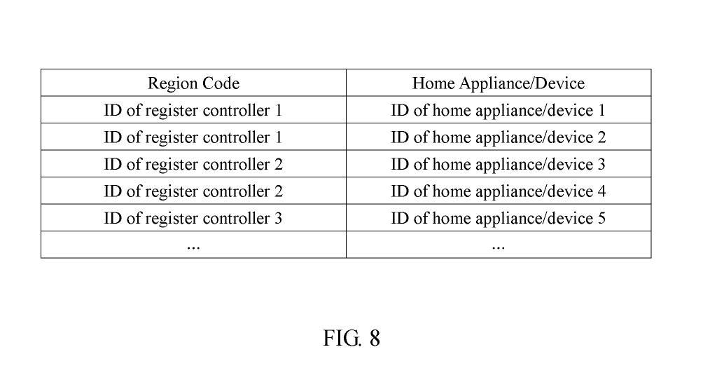

Referring to FIG. 8, each of the home appliances 30 located within the communication range of the registration controller 36 receives the registering code sent by the registration controller 36 via the fourth wireless communication unit 320, and establishes communication with the smart gateway 20 according to the UID of the smart gateway 20 included in the registering code. Each home appliance 30 sends a registration signal to the smart gateway 20. The registration signal includes the UID of the registration controller 36 and the UID of the home appliance 30.

The smart gateway 20 generates a region code corresponding to the UID of the registration controller 36 in response to the received register request sent by the registration controller 36. In this embodiment, the region code is the UID of the registration controller 36.

The smart gateway 20 assigns a corresponding region code to the home appliances 30 according to the UID of the registration controller 36 in the registration signal, and the UIDs of the home appliances 30 and the corresponding region code are recorded in a mapping table. In this embodiment, the smart gateway 20 stores the mapping table in the system information of the home system 100.

In this embodiment, the home system 100 includes a number of registration controllers 36 distributed in each room of the home system 100. Each of the registration controllers 36 includes a unique UID. The home appliances 30 located in one room respond to the trigger of the registration controller 36 in the same room to register with the smart gateway 20. The smart gateway 20 assigns a region code to every registering home appliance 30 and stores the UID of the home appliance 30 and the region code in the mapping table. Because the UIDs of the registering home appliances 30 and the UIDs of the registration controllers 36 are all unique, until the registered home appliance 30 is moved to a new room and receives a new register code sent by another registration controller 36, the region code corresponding to the UID of the home appliance 30 stored in the mapping table will not be replaced by a new region code.

In other embodiments, in response to a user's operation on the trigger unit 364, the third wireless communication unit 361 sends a registering code to the home appliances 30 located within the communication range of the registration controller 36, and the third PLC modem unit 363 sends a register request to the smart gateway 20 via the PLC modem units. The smart gateway 20 calls all the electronic devices on the power line to directly send their UIDs in response to the register request. In detail, the smart gateway 20 signals all the electronic devices on the power line in response to the register request to determine whether or not the UID of the registration controller 36 included in the register code received by the home appliance 30 is the same as the UID of the registration controller 36 included in the register request received by the smart gateway 20. If so, the smart gateway 20 requests the home appliances 30 to send their UIDs to the smart gateway 20 via the PLC modem units.

In other embodiments, a safety certification process is carried out in the registering process, either when registering the home appliance 30 on the smart gateway 20, or registering the registration controller 36 on the smart home system 100. When the registration controller 36 is registered on the smart home system 100, the first wireless communication unit 204 of the smart gateway 20 and the third wireless communication unit 361 of the registration controller 36 establish communication with each other. The smart gateway 20 sends its UID and a code to the registration controller 36. The code can be the UID of the smart gateway 20 or a random code. The registration controller 36 encrypts the registration request with the code before sending the registration request to the smart gateway 20. The registration controller 36 also packages the code in the registering code, and sends the registering code to the home appliances 30. The home appliance 30 also encrypts the registration signal with the received code. In this way, only the smart gateway 20 that generates the code can decode the registration request sent by the registration controller 36 and the registration signal sent by the home appliance 30. Therefore, other smart gateways connected to the power line, such as a smart gateway in a neighbor's house, cannot obtain the details of the registration request and the registration signal to control the home appliances 30.

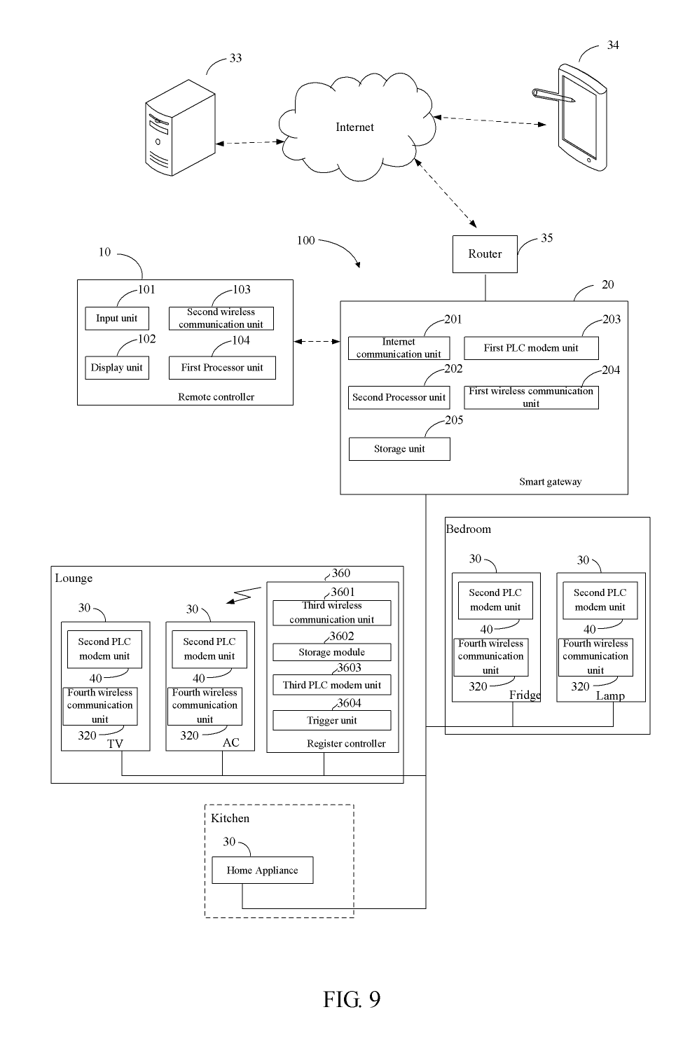

Referring to FIG. 9, in another embodiment, the smart home system 100 includes only one registration controller 360. The registration controller 360 includes a third wireless communication unit 3601, a storage module 3602, a third PLC modem unit 3603 and a trigger unit 3604. The registration controller 360 is connected to the power line, and sends a registration request to the smart gateway 20 in PLC manner to register the home appliances 30 located within the communication range of the registration controller 360.

As previously mentioned, the registration controller 360 needs to be registered in the smart home system 100 in an initial state. To register the registration controller 360, the registration controller 360 is connected to the power line, and is located within the communicating range of the first wireless communication unit 204 of the smart gateway 20, and a registering program is run on the smart gateway 20. Then, the first wireless communication unit 204 of the smart gateway 20 and the third wireless communication unit 3601 of the registration controller 360 establish communication with each other, and the smart gateway 20 sends its UID to the registration controller 360. The registration controller 360 receives the UID of the smart gateway 20 and saves it into the storage module 3602, thereby completing the registration process.

After registering the registration controller 360 in the smart home system 100, the home appliances 30 can be registered in the smart gateway 20, the registration controller 360 must be located in the room containing the home appliances 30 needing to be registered or within the communication range of the home appliances 30. The registration controller 360 sends a register request to the smart gateway 20 via the third PLC modem unit 3603, in response to a user's input on the trigger unit 3604. The register request includes the UID of the registration controller 360. The smart gateway 20 generates a serial code, and a region code composing of the serial code and the UID of the registration controller 360, the smart gateway 20 further sends the serial code to the registration controller 360.

The registration controller 360 receives the serial code via the third PLC modern unit 3603, and sends a registration code to the home appliances 30 located within the communication range of the registration controller 360 via the third wireless communication unit 3601. The registration code includes the UID of the smart gateway 20, the UID of the registration controller 36, and the serial code.

Each of the home appliances 30 located within the communication range of the registration controller 360 receives the registration code sent by the registration controller 360 via the fourth wireless communication unit 320, and establishes communication with the smart gateway 20 according to the UID of the smart gateway 20 included in the registration code. Each home appliance 30 sends a registration signal to the smart gateway 20. The registration signal includes the serial code, the UID of the registration controller 360, and the UID of the home appliance 30.

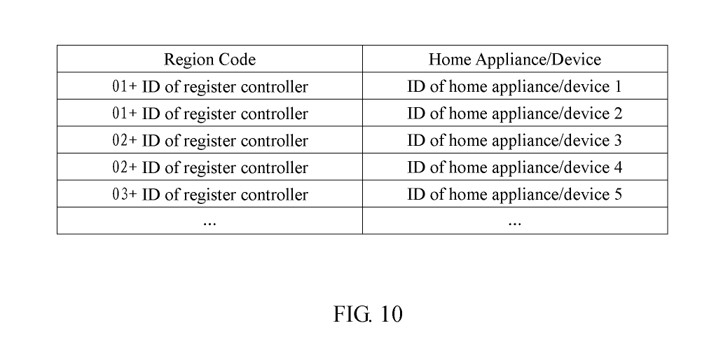

Referring to FIG. 10, the smart gateway 20 assigns the corresponding region code to the home appliance 30 according to the serial code and the UID of the registration controller 360 contained in the registration signal, and records the UID of the home appliance 30 and the corresponding region code in a mapping table.

In this embodiment, the home system 100 includes only one registration controller 360, the registration controller 360 being taken to each room in turn of the smart home system 100, to register the home appliances 30 located in different rooms. The serial codes generated by the smart gateway 20 responding to a registration request are different each time. Therefore, the smart gateway 20 can generate different region codes to the home appliances 30 in different rooms of the smart home system 100, for example, when the registration controller 360 is located in a lounge of the smart home system 100, the smart gateway 20 receives a registration request and generates a first serial code, such as 01, the region code corresponding to the home appliances 30 in the lounge is composed of the first serial code “01” and the UID of the registration controller 360; then the registration controller 360 is taken to a bedroom of the smart home system 100, the smart gateway 20 receives a registration request again and generates a second serial code, such as 02, the region code corresponding to the home appliances 30 in the bedroom is composed of the second serial code “02” and the UID of the registration controller 360.

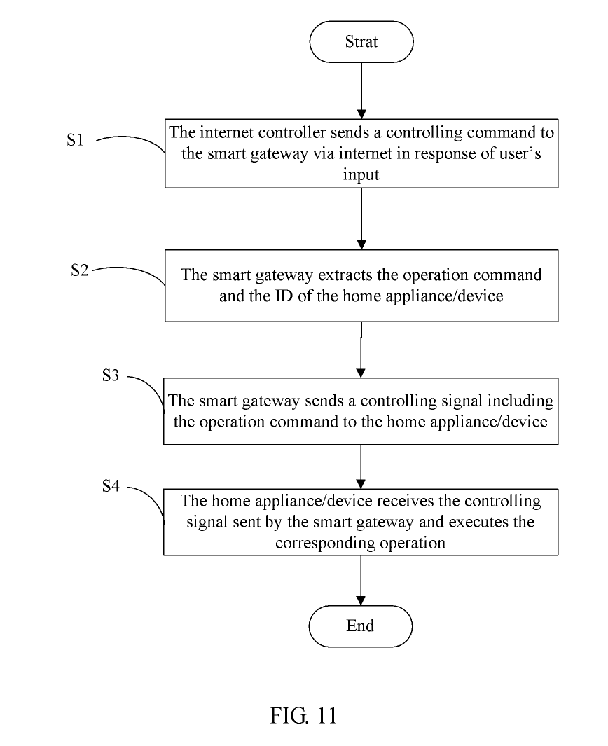

Referring to FIG. 11, a flowchart of a remote controlling method for controlling the home appliances 30 of the smart home system 100 is illustrated. The method includes the following steps, each of which is tied to various components contained in the smart home system 100 as shown in FIG. 2.

In step S1, the Internet controller 34 sends a controlling command to the smart gateway 20 via Internet in response to user's input, the controlling command includes an operation command and the UID of a home appliance 30 which is assigned to execute the operation command.

In step S2, the smart gateway 20 extracts the operation command and the UID of the home appliance 30 which is assigned to execute the operation command from the received controlling command. In detail, the Internet communication unit 201 of the smart gateway 20 receives the controlling commands sent by the server 33 or the Internet controller 34 and transmits the controlling commands to the second processor unit 202, the second processor unit 202 further extracts the operation command and the UID of the home appliance 30 which is assigned to execute the operation command from the controlling command. In this embodiment, the UID of the home appliance 30 is the UID of the second PLC modern unit 40.

In step S3, the smart gateway 20 sends a controlling signal including the operation command to the home appliance 30 which is assigned to execute the operation command. In detail, the main controlling module 2032 of the first PLC modem unit 203 encodes the controlling signal according to the operation command and the UID of the home appliance 30 which is assigned to execute the operation command extracted by the second processor unit 202, and the power carrier transmission module 2031 loads the controlling signal to the power line for sending the controlling signal to the target home appliance 30.

In step S4, the home appliance 30 receives the controlling signal sent by the smart gateway 20 and executes the required operation according to the operation command included in the controlling signal. In detail, the power carrier transmission module 41 of the second PLC modem unit 40 demodulates the controlling signals from the power line and determines whether or not the UID of the controlling signal matches the UID of itself; if the UIDs match, the power carrier transmission module 41 receives the controlling signal; the main controlling module 42 extracts the operation command included in the controlling signal and the home appliance 30 executes the operation according to the operation command.

In other embodiments, the smart gateway 20 communicates with each of the home appliances 30 via a wireless communication mode, wherein the wireless communication mode includes, but is not limited to, Infrared (IR), BLUETOOTH, Z-wave, NFC, Zigbee, WIFI, or other communication technologies. In that way, in step 4, the smart gateway 20 sends a controlling signal via the first wireless communication unit 204. In step S5, the home appliance 30 receives the controlling signal via the fourth wireless communication unit 320.

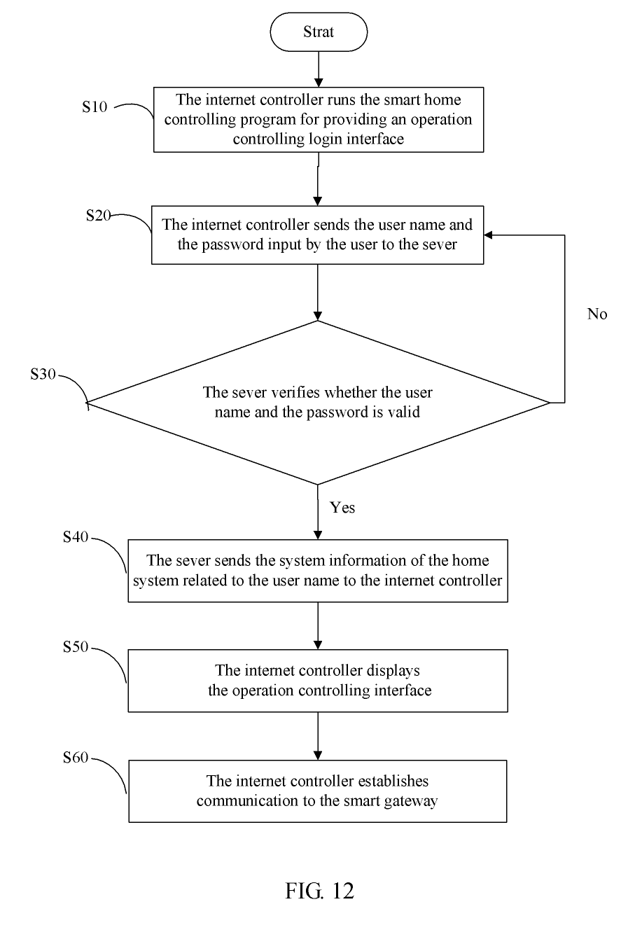

Referring to FIG. 12, the remote controlling method of the home appliances 30 of the smart home system 100 shown in FIG. 11 further includes the following steps before the step S1:

In step S10, the Internet controller 34 runs the smart home controlling program for providing an operation control login interface.

In step S20, the Internet controller 34 sends the user name and the password input by the user to the server 33.

In step S30, the server 33 verifies whether the user name and the password are valid; if yes, process goes to step S40 if not, it reverts to step S20.

In step S40, the server 33 sends the system information of the home system 100 related to the user name to the Internet controller 34.

In step S50, the Internet controller 34 displays the operation controlling interface.

In step S60, the Internet controller 34 establishes communication with the smart gateway 20 according to the location and setting parameters of the router 35 included in the system information.

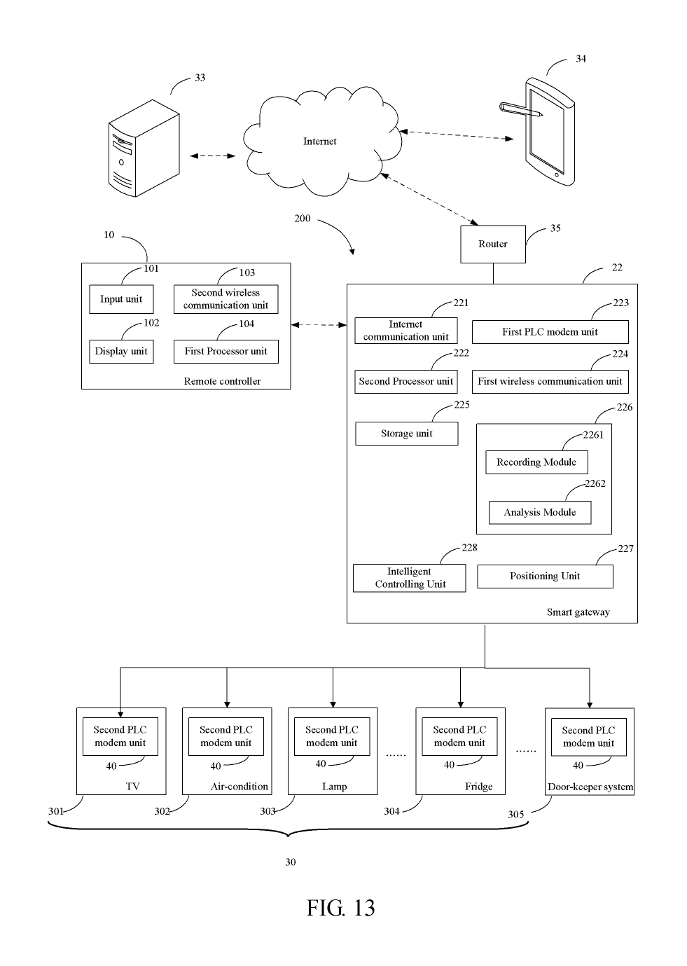

Referring to FIG. 13, the smart home system 200 is similar to the smart home system 100 mentioned in FIG. 2, the smart home system 200 also includes a remote controller 10, a smart gateway 22 communicating with a server 33 and an Internet controller 34 via the Internet, the smart gateway 22 also communicates with a number of home appliances 30. The home appliances 30 include, but are not limited to, a television 301, an air-condition 302, a lamp 303, a fridge 304, a door-keeper system 305, a socket, a fan, and an automatic curtain. The smart gateway 22 includes an Internet communication unit 221, a second processor unit 222, a first PLC modem unit 223, a first wireless communication unit 224, and a storage unit 225.

The differences between the smart home system 200 and the smart home system 100 is that, the mart home system 200 further includes a learning unit 226, a positioning unit 227, and an intelligent controlling unit 228. In this embodiment, the learning unit 226, the positioning unit 227, and the intelligent controlling unit 228 are arranged in the smart gateway 22.

For example, the Internet controller 34 is a smart portable device, such as cell phone. Because of the cell phone is with a user, the position of the user can be determined via the position of the cell phone. The cell phone may have positioning function base on Global Positioning System (GPS) or communication network.

The positioning unit 227 is configured to obtain the respective positions of the users of the smart home system 200. In this embodiment, the positioning unit 227 obtains the positions of the users of the smart home system 200 from the Internet controllers 34 carried by users. In detail, the Internet controllers 34 detects their locations and sends the locations to the smart gateway 22. The positioning unit 227 of the smart gateway 22 receives the locations and determines whether the user has arrived at home according to the location of the Internet controllers 34 carried by users. In another embodiment, the positioning unit 227 determines the distance between the current position of the user and the building in which the smart home system 200 is located, according to the location of the Internet controllers 34 carried by users.

In an alternative embodiment, the positioning unit 227 obtains the positions of the users from the door-keeper system 305 of the home appliance 30. In this embodiment, the door-keeper system 305 is based on Near Field Communication (NFC) or Radio Frequency Identification (RFID), or the other contact or contactless door-keeper technology. Each user of the smart home system 200 may have an access card, and each access card includes a unique code corresponding to a user. A table of the relationships between the unique codes and the users is stored in the storage unit of the smart gateway 22. The door-keeper system 305 communicates with the smart gateway 22 via a wired or wireless communication mode, wherein the wireless communication mode includes, but is not limited to, Infrared (IR), Bluetooth, Z-wave, NFC, Zigbee, WIFI, or other communication technologies. The wired communication mode can be PLC, OPLC, wired Internet communication, coaxial cable communication, telephone line communication, or other communication technologies.

Because of the access card is used to open a door of the door-keeper system 305 when user enters into house from outside, the positioning unit 227 can determine that a user has arrived at home when the unique code of the access card is received. In detail, when the door-keeper system 305 is triggered by an access card, the door-keeper system 305 sends the unique code of the access card to the smart gateway 22, the positioning unit 227 of the smart gateway 22 receives the unique code and determines that the corresponding user has arrived at home.

In an alternative embodiment, the positioning unit 227 obtains the positions of the users from the images gathered by a camera employed in the smart home system 200. In this embodiment, the positioning unit 227 analyses the images gathered by the camera to determine whether a face is contained in the images and if so to recognize a face of a user by facial recognition technologies, thus to determine whether the user has arrived at home.

The learning unit 226 includes a recording module 2261 and an analysis module 2262. When the positioning unit 227 determines that the user arrives at home, the recording module 2261 records in the storage unit 225 as an operational record the identification information of the user and the controlling command received by the smart gateway 22 within a first predetermined time period after the user arrives at home. For example, the positioning unit 227 determines that the user A has arrived at home according to the location detected and sent by the Internet controllers 34, and within the first predetermined time period after the user arrives at home, the smart gateway 22 receives the following controlling commands:

(1) A controlling command including an operation command of “Power On” applied on the “TELEVISION”;

(2) A controlling command including an operation command of “Unfolding/Draw” applied on the “Automatic Curtain”;

(3) A controlling command including an operation command of “Turn on” applied on the “Lamp Of Bathroom”.

The recording module 2261 records the identification information of the user A and the three controlling commands in the storage unit 225 as three operational records respectively.

The analysis module 2262 analyzes the operation records and determines which type of controlling commands is deemed a habit according to the number of times that the controlling command is inputted by the same user within a second predetermined time period, and records the habit controlling command and the identification information of the user in an intelligent command table. The intelligent command table is stored in the storage unit 225. In detail, the analysis module 2262 analyses the operational records and determines whether the number of times that the controlling command is inputted by the same user within a second predetermined time period has reached or is equal to a predetermined number of times; if yes, the analysis module 2262 records the controlling command as a habit and the identification information of the corresponding user in the intelligent command table.

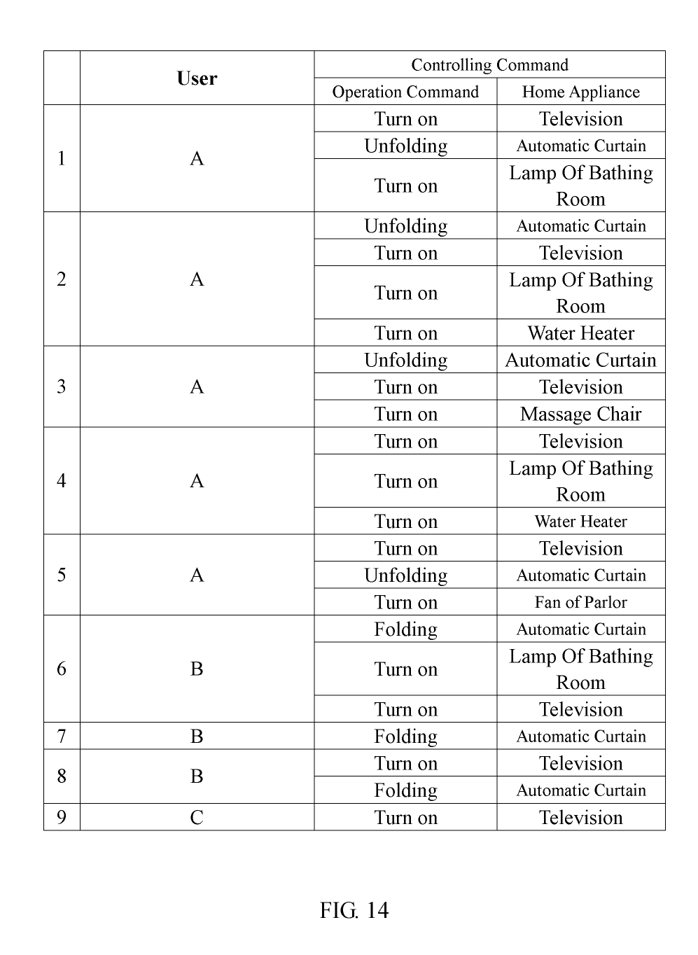

Referring to FIG. 14, a table is provided showing a number of operational records recorded within a second predetermined time period, according to an exemplary embodiment. In this embodiment, the second predetermined time period is five days, the predetermined number of times is three, a total of nine operational records have been recorded by the recording module 2261; five operation records relate to the user A, three operation records relate to the user B, and one operation records relate to the user C.

The controlling command including an operation command of “Power On” applied on the “TELEVISION” by user A appears five times in the table, the analysis module 2262 determines that this command inputted by user A is a habit, and records this controlling command and the identification information of the user A in the intelligent command table.

Similarly, the controlling command including an operation command of “Unfolding” applied on the “Automatic Curtain” by user B appears four times in the table, the analysis module 2262 determines that this command inputted by user B is a habit, and records this controlling command and the identification information of the user B in the intelligent command table.

Also, the controlling command including an operation command of “Turn on” applied on the “Lamp Of Bathing Room” by user A is deemed a habit, and the controlling command including an operation command of “Folding” applied on the “Automatic Curtain” by user B is also deemed a habit.

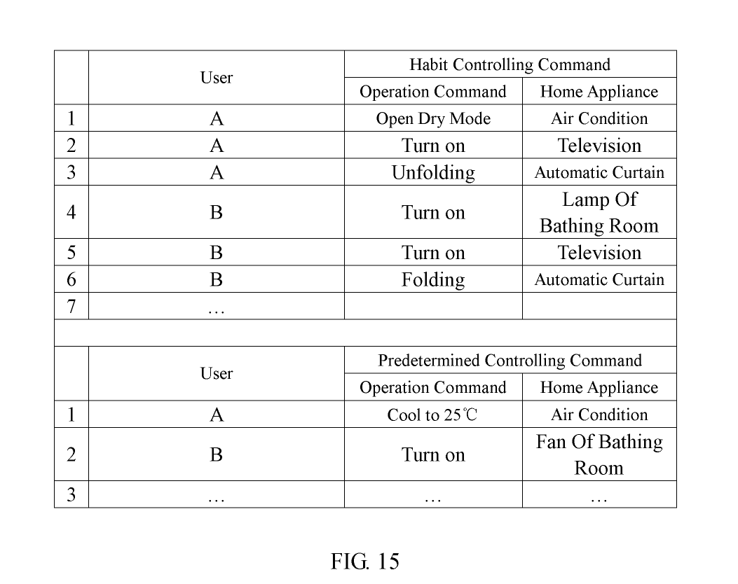

Referring to FIG. 15, a number of habit controlling commands and the identification information of the corresponding users are recorded in the intelligent command table. The intelligent command table further includes one or more identification information of predetermined users and predetermined controlling commands. The identification information of predetermined users and the corresponding predetermined controlling commands are set by each user. For example, the identification information of predetermined user A, and a corresponding predetermined controlling command “cool to 25° C.” to “air conditioner” also show in FIG. 15.

Both of the habit controlling command and the predetermined controlling command are intelligent controlling commands. When the positioning unit 227 detects that the user arrives at home, the smart home system 200 calls the corresponding habit controlling command or the predetermined controlling command to control the relevant home appliance 30 to execute the necessary operations.

In an embodiment, when the positioning unit 227 detects that a user arrives at home, the intelligent controlling unit 228 sends the habit controlling command or the predetermined controlling command corresponding to the user, to the second processor unit 222 of the smart gateway 22.

In an alternative embodiment, the positioning unit 227 obtains the positions of the users and determines when the users arrive within a predetermined distance range. In detail, the positioning unit 227 determines whether the distance between the current position of a user and the building in which the smart home system 200 is located is less than a predetermined distance. When the positioning unit 227 detects that the distance between the current position of a user and the building in which the smart home system 200 is located is less than the predetermined distance, the intelligent controlling unit 228 sends the habit controlling command or the predetermined controlling command corresponding to the user, to the second processor unit 222 of the smart gateway 22.

The second processor unit 222 receives the predetermined controlling command or the habit controlling command, and extracts the operation command and the UID of the home appliance 30, which executes the operation command from the predetermined controlling command or the habit controlling command. The controlling process of the smart home system 200 is similar to that of the smart home system 100 mentioned before.

With such configuration, the smart home system 200 tracks the users' habits of controlling command and adjusts itself to match the users' habits.

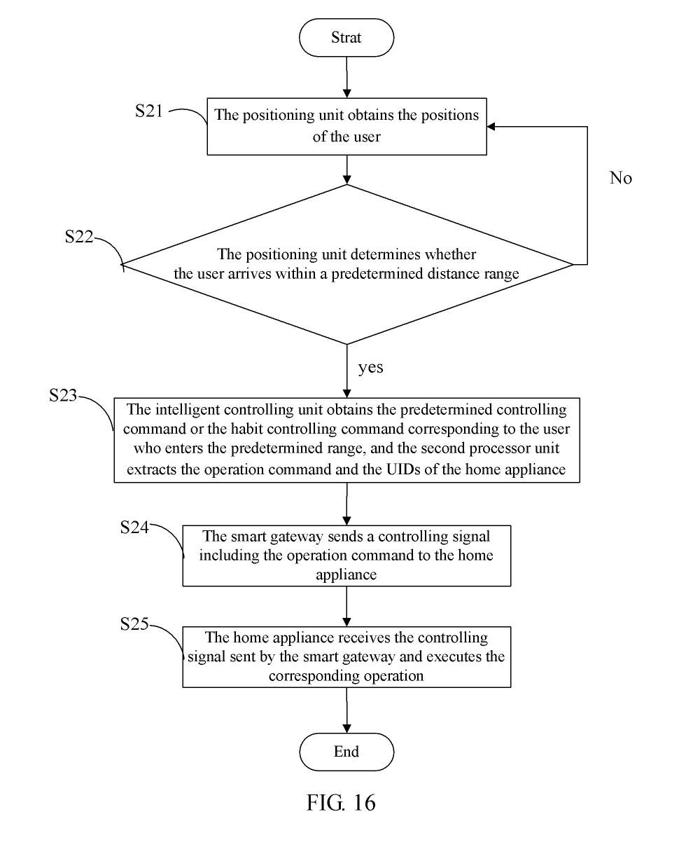

Referring to FIG. 16, a flowchart of a controlling method of the home appliances 30 of the smart home system 200 according to an embodiment is illustrated. The method includes the following steps, each of which is tied to various components contained in the smart home system 200 as shown in FIG. 13.

In step S21, the positioning unit 227 obtains the positions of the users. In detail, the positioning unit 227 obtains the positions of users according the locations established by GPS.

In step S22, the positioning unit 227 determines whether the user arrives within a predetermined distance range; if yes, process goes to step S23, otherwise it goes back to step S21. In an alternative embodiment, the predetermined distance range is a predetermined distance from the building in which the smart home system is located, or the predetermined distance range may be restricted to the user arriving at home.

In step S23, the intelligent controlling unit 228 of the smart gateway 22 obtains the predetermined controlling command or the habit controlling command corresponding to the user who enters within the predetermined distance range, and the second processor unit 222 of the smart gateway 22 extracts the operation command and the UIDs of the home appliance 30, which is assigned to execute the operation command from the predetermined controlling command or the habit controlling command.

In step S24, the smart gateway 22 sends a controlling signal including the operation command to the home appliance 30 which is assigned to execute the operation command.

In step S25, the home appliance 30 receives the controlling signal sent by the smart gateway 22 and executes the required operation according to the operation command included in the controlling signal.

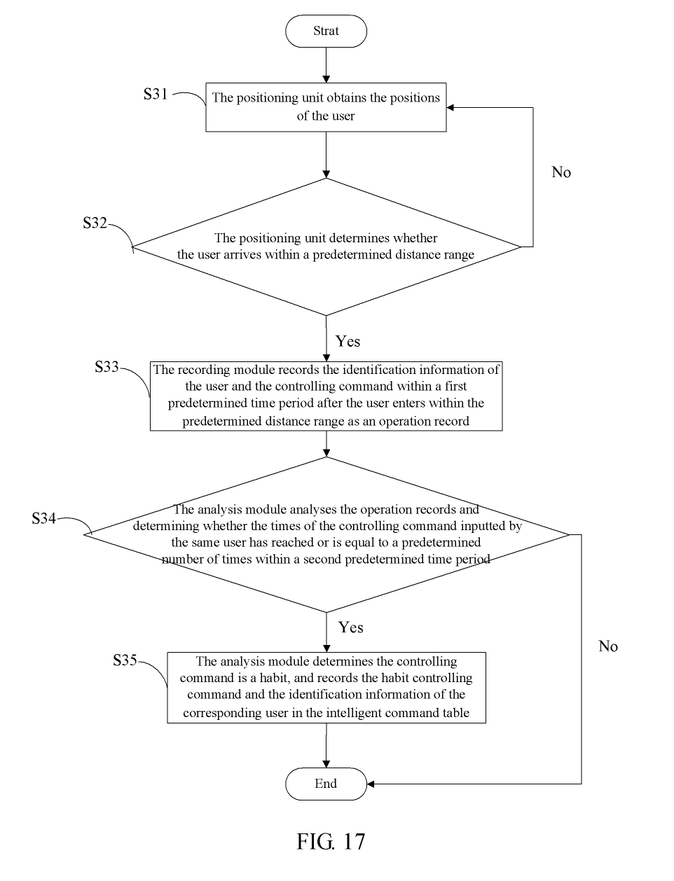

Referring to FIG. 17, a flowchart of a habit learning method of the smart home system 200 according to an exemplary embodiment is illustrated. The method includes the following steps, each of which is tied to various components contained in the smart home system 200 as shown in FIG. 13.

In step S31, the positioning unit 227 obtains the positions of one or more users.

In step S32, the positioning unit 227 determines whether a user arrives within a predetermined distance range; if yes, process goes to step S33, otherwise it goes back to step S31.

In step S33, the recording module 2261 of the smart gateway 22 records in the storage unit 225 as an operational record the identification information of the user and the controlling command received by the smart gateway 22 within a first predetermined time period after the user enters within the predetermined distance range.

In step S34, the analysis module 2262 of the smart gateway 22 analyses the operational records and determines whether the number of times that the controlling command has been inputted by the same user has reached or is equal to a predetermined number of times within a second predetermined time period; if yes, the process goes to step S35, otherwise the process ends.

In step S35, the analysis module 2262 of the smart gateway 22 determines that the controlling command is a habit, and records the habit controlling command and the identification information of the corresponding user in the intelligent command table.

The disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart controlling method applied to a smart home system, for controlling a plurality of home appliances of the smart home system, the smart home system comprising a smart gateway communicating to the home appliances, and an intelligent command table comprising a plurality of controlling commands and identification information of the users corresponding to each controlling command, each of the controlling commands comprising an operation command and an unique identification code of a home appliance which is assigned to execute the operation command; the smart gateway controlling the home appliances to execute a corresponding operation according to a received control command; the smart controlling method comprising the following steps:
a, obtaining positions of the users;
b, determining whether the user arrives within a predetermined distance range using the smart gateway, if yes, goes to step c, otherwise, goes back to step a,
c, obtains the controlling command corresponding to the user who enters within the predetermined distance range, and extracting the operation command and the unique identification code of the home appliance which is assigned to execute the operation command from the controlling command using the smart gateway;
d, sending a controlling signal including the operation command to the home appliance which is assigned to execute the operation command using the smart gateway; and
e, receiving the controlling signal sent by the smart gateway and executing the corresponding operation according to the operation command included in the controlling signal using the home appliance.

2. The smart controlling method as described in claim 1, wherein the predetermined distance range is a predetermined distance from the building in which the smart home system is located.

3. The smart controlling method as described in claim 1, wherein the controlling command comprises a plurality of habit controlling commands and predetermined controlling commands.

4. The smart controlling method as described in claim 3, further comprising the steps:
S31, obtaining positions of the users;
S32, determining whether the user arrives within a predetermined distance range using the smart gateway, if yes, goes to step S33, otherwise, goes back to step S31,
S33, recording the identification information of the user and the controlling command received by the smart gateway within a first predetermined time period after the user enters the predetermined distance range, as an operation record;
S34, analyzing operation records and determining whether the number of times that the controlling command has been inputted by the same user has reached or is equal to a predetermined number of times within a second predetermined time period, if yes, the process goes to step S35, otherwise, goes to end;
S35, determining that the controlling command is a habit, and recording the habit controlling command and the identification information of the corresponding user in the intelligent command table.

5. The smart controlling method as described in claim 1, wherein the remote controller communicates with the smart gateway via wired or wireless network technology, the wireless network technology is selected from a group consisting of Infrared (IR), Bluetooth, Z-wave, NFC, Zigbee, WIFI or WIPI communication technologies, the wired communication technology is selected from a group consisting of Power Line Communication, Optical Fiber Power Line Communication, Internet communication, coaxial cable communication, and telephone line communication technologies.

6. A smart gateway applied to a smart home system, the smart gateway communicating with a plurality of home appliances and a positioning unit configured to detecting current state parameter values, the smart gateway comprising:
a storage unit storing an intelligent command table comprising plurality of controlling commands and identification information of the users corresponding to each controlling command, each of the controlling commands comprising an operation command and an unique identification code of a home appliance which is assigned to execute the operation command;
a positioning unit configured to obtain the positions of the user and determining whether the user arrives within a predetermined distance range;
an intelligent controlling unit configured to obtain the controlling command corresponding to the user who enters within the predetermined distance range;
a processor unit configured to extract the operation command and the unique identification code of the home appliance which is assigned to execute the operation command from the controlling command; and
a communication unit configured to send a controlling signal comprising the operation command to the home appliance which is assigned to execute the operation command according to the unique identification code of the home appliance.

7. The smart gateway as described in claim 6, wherein the predetermined distance range is a predetermined distance from the building in which the smart home system is located.

8. The smart gateway as described in claim 6, wherein the communication unit is a Power Line Communication modern unit, the Power Line Communication modern unit sends the controlling signal to the home appliance via power line.

9. The smart gateway as described in claim 6, wherein the controlling command comprises a plurality of habit controlling commands and predetermined controlling commands.

10. The smart gateway as described in claim 9, further comprising a learning unit, wherein the learning unit comprises:
a recording module configured to record the identification information of the user and the controlling command received by the smart gateway within a first predetermined time period after the user enters within the predetermined distance range, as an operation record; and
an analysis module configured to determine that a controlling command is a habit when the number of times that the controlling command has been inputted by the same user has reached or is equal to a predetermined number of times within a second predetermined time period, and record the habit controlling command and the identification information of the corresponding user in the intelligent command table.

11. The smart gateway as described in claim 6, wherein the smart gateway communicates to an Internet controller comprising a Global Positioning System, the positioning unit obtains the positions of the users according locations sent by the Global Positioning System.

12. The smart gateway as described in claim 6, wherein the smart gateway communicates to a door-keeper system, the door-keeper system sends a unique code of the access card carried with a user to the smart gateway, the positioning unit receives the unique code and determines that the position of the user is at home.

13. The smart gateway as described in claim 6, wherein the positioning unit analyses the images gathered by the camera to determine whether the face of the user is contained in the images via facial recognition technologies, thereby determining whether the position of the user is at home.

14. A smart home system, comprising a plurality of home appliances, a smart gateway connected to the Internet and communicating with a plurality of home appliances, a positioning unit configured to obtain the positions of the user and determining whether the user arrives a predetermined distance range, and an intelligent command table comprising a plurality of controlling commands and identification information of the users corresponding to each controlling command, each of the controlling commands comprising an operation command and an unique identification code of a home appliance which is assigned to execute the operation command; the smart gateway controlling the home appliances to execute a corresponding operation according to a received control command; the mart controlling method, the smart gateway comprising:
an intelligent controlling unit configured to obtain the controlling command corresponding to the user who enters within the predetermined distance range
a processor unit configured to extract the operation command and the unique identification code of the home appliance which is assigned to execute the operation command from the controlling command; and
a communication unit configured to send a controlling signal comprising the operation command to the home appliance which is assigned to execute the operation command according to the unique identification code of the home appliance;
the home appliance configured for receiving the corresponding controlling signal sent by the smart gateway, and executing the corresponding operation according to the operation command included in the controlling signal.

15. The smart home system as described in claim 14, wherein the predetermined distance range is a predetermined distance from the building in which the smart home system is located.

16. The smart home system as described in claim 14, wherein the communication unit is a Power Line Communication modern unit, the Power Line Communication modern unit sends the controlling signal to the home appliance via power line.

17. The smart home system as described in claim 14, wherein the controlling command comprises a plurality of habit controlling commands and predetermined controlling commands.

18. The s smart home system as described in claim 14, further comprising a learning unit, wherein the learning unit comprises:
a recording module configured to record the identification information of the user and the controlling command received by the smart gateway within a first predetermined time period after the user enters within the predetermined distance range, as an operation record; and
an analysis module configured to determine that a controlling command is a habit when the number of times that the controlling command has been inputted by the same user has reached or is equal to a predetermined number of times within a second predetermined time period, and record the habit controlling command and the identification information of the corresponding user in the intelligent command table.

19. The smart home system as described in claim 14, wherein the smart gateway communicates to an Internet controller comprising a Global Positioning System, the positioning unit obtains the positions of the users according locations sent by the Global Positioning System.

20. The s smart home system as described in claim 14, wherein the smart gateway communicates to a door-keeper system, the door-keeper system sends a unique code of the access card carried with a user to the smart gateway, the positioning unit receives the unique code and determines that the position of the user is at home.
